(19) United States
(12) Patent Application Publication
(10) Pub. No.: US 2026/0340065 A1
(43) Pub. Date: Oct. 29, 2026

(54) ENABLING AGENTS UTILIZING WEBSITE AND APPLICATION ANNOTATIONS

(71) Applicant: Microsoft Technology Licensing, LLC, Redmond, WA (US)

(72) Inventors: Suman K. NATH, Redmond, WA (US); Morris Eli SHARP, Seattle, WA (US); Lenin Ravindranath SIVALINGAM, Redmond, WA (US); Fazle Elahi FAISAL, Bothell, WA (US)

(21) Appl. No.: 19/189,145

(22) Filed: Apr. 24, 2025

(51) Int. Cl. G06F 16/958

(52) U.S. Cl. CPC G06F 16/958

(57) ABSTRACT

An annotation tool receives, from a website or application, a graphical user interface (GUI) definition and a GUI image generated by the website or application. The tool identifies an interactive element visible in the GUI image and corresponding code in the GUI definition for the interactive element and infers, from the GUI image and the GUI definition, a description of the interactive element, the description including, in natural language, a purpose of the interactive element. The tool generates an annotation for the interactive element, the annotation comprising the description and updates the website or application based on the annotation. In example scenarios, the annotation is used by an artificial intelligence agent for performing actions on the GUI without referring to the GUI image.

### BACKGROUND

Modern artificial intelligence (AI) agents use generative AI technologies, including language models, to perform tasks based on a verbal or written prompt provided to the agent via a user interface. AI agents can run locally on a user’s hand-held mobile device, laptop or desktop computer, or can run in remote datacenters. However, they are generally provided by a particular entity and are limited to performing specific types of tasks that relate to the products and/or services that the entity provides. For example, well-known AI agents are capable of purchasing an item on a marketplace platform on behalf of a user in response to a voice prompt. In enterprises, AI agents optimize workflows, perform cybersecurity tasks, and perform decision making in industries like finance, healthcare, and retail.

Example solutions for enabling agents utilizing websites and application annotations are described herein. The disclosed examples are described in detail below with reference to the accompanying drawing figures listed below. The following summary is provided to illustrate some examples disclosed herein.

In certain examples, an annotation tool receives, from a website or application, a graphical user interface (GUI) definition and a GUI image generated by the website or application. The tool identifies an interactive element visible in the GUI image and corresponding code in the GUI definition for the interactive element and infers, from the GUI image and the GUI definition, a description of the interactive element, the description including, in natural language, a purpose of the interactive element. The tool generates an annotation for the interactive element, the annotation comprising the description and updates the website or application based on the annotation. In example scenarios as described below, the annotation is used by an artificial intelligence agent for performing actions on the GUI without again referring to the GUI image.

In another aspect of the invention described herein, an AI agent is configured to receive, from the user, a task description. The AI agent receives, from the website or application, a GUI definition corresponding to the GUI generated by the website or application, the GUI comprising an interactive element, the GUI definition being in declarative textual form, such as hypertext markup language (HTML) or similar, and including an annotation for the interactive element, the annotation including a tag indicating that the annotation provides a description of a purpose of the interactive element and a text string describing the purpose of the interactive element. The AI agent provides the task and the GUI definition to the GAI model and obtains therefrom an action to be performed on the interactive element of the GUI, the action being based on the annotation and the task description. The AI agent further transmits, to a browser or the application, an instruction to perform the action.

### BRIEF DESCRIPTION OF THE DRAWINGS

The disclosed examples are described in detail below with reference to the accompanying drawing figures listed below:

FIG. 1A illustrates by way of example a system for deploying and accessing an AI agent.

FIG. 1B illustrates an alternative implementation wherein the agent is deployed as a centralized service that is remotely accessed.

FIG. 2 shows a hybrid block diagram and flowchart illustrating by way of example an implementation of an annotation tool.

FIG. 3 shows a flowchart illustrating by way of example a procedure for generating annotations for interactive graphical user interface elements.

FIG. 4 shows a flowchart that illustrates way of example a procedure for testing inferred actions associated with interactive elements on a web page or application and generating corresponding annotations to update the web page or application accordingly.

FIGS. 5A, 5B, and 5C show examples of annotations in hypertext markup for use by an AI agent.

FIG. 6 shows a block diagram illustrating by way of example an architecture of an action engine.

FIG. 7 illustrates an example procedure performed by an AI agent.

FIG. 8 is a time-space diagram illustrating by way of example a communication sequence among various system entities involved in performing a task using annotated graphical user interface information.

FIGS. 9A and 9B show flowcharts illustrating by way of example a procedure that may be performed by a service provider to enable an AI agent to interact with a user-facing application or website.

FIG. 10 shows an example browser window showing an example web page with interactive elements.

FIG. 11 is a block diagram of an example computing device for implementing aspects disclosed herein.

Corresponding reference characters indicate corresponding parts throughout the drawings. Any of the figures or drawings may be combined into a single example or embodiment.

### DETAILED DESCRIPTION

Artificial intelligence (AI) agents are, in some cases, embedded into applications and interact with users and/or other systems. They use machine learning models built on neural networks that are trained using various training techniques, including supervised, unsupervised, or reinforcement learning. AI agents can be driven by a special-purpose model or an existing general-purpose generative AI (GAI) model. In either case, AI agents additionally require a number of components including a front end for user or automated interactions, a back end having an application programming interface (API) for integrating the agent with the AI model, memory and context management for long-term memory (e.g., to retain session content, and possibly retrieval augmented generation (RAG) functionality for fetching external data to enhance the agent’s operation). Often, agents require custom code for advanced tasks, and specialized plugins and tools to connect agents with external systems such as calendars, emails, etc.

One technical challenge for custom AI agents is to perform tasks using existing human-facing interfaces that already exist, such as websites and mobile applications, which are designed with human interaction in mind. Solutions have recently been introduced that leverage GAI systems to perform tasks on behalf of users using websites designed for human interaction, but they are computationally expensive and non-performant. In one approach, an agent is integrated with a web browser. Upon instructing the agent to perform a task, it sends the task to a remote GAI model which instructs the agent to navigate to a particular web page, then captures an image of the user interface generated by the web browser from the web page and sends the image to the GAI model for interpretation. The GAI model provides additional interaction instructions such as to click on a particular interactive user interface element, or type certain text into a text field generated by the website, and the process repeats until the task is complete. The back-and-forth communications and heavy reliance on GAI interactions results in high cost and slow performance.

In contrast, by providing annotations for actions in GUI definitions, the technology described herein improves the accuracy and performance of AI agents that access a web interface designed for human interaction. The AI agent can perform a task with reduced processor load, less memory space required, increased processing speed, energy savings, reduced hardware requirements, enhanced reliability, reduced error rate, and reduced network bandwidth usage compared to prior approaches. Specifically, the annotations obviates a need to forward screenshots of the GUI to the GAI model at runtime, thereby reducing network bandwidth usage and GAI processing of the screenshot images. This greatly reduces the overall computational cost of performing a task on a website or app. In comparison to approaches relying on analysis of unannotated GUI definition such as HTML, the annotated GUI definition enables much more accurate identification of actions because the annotations are determined by a GAI model based on the graphical display at annotation time. The technology therefore utilizes the inferencing power of generative artificial intelligence but significantly reduces the access frequency thereof, thereby reducing the cost of deploying and using AI agents.

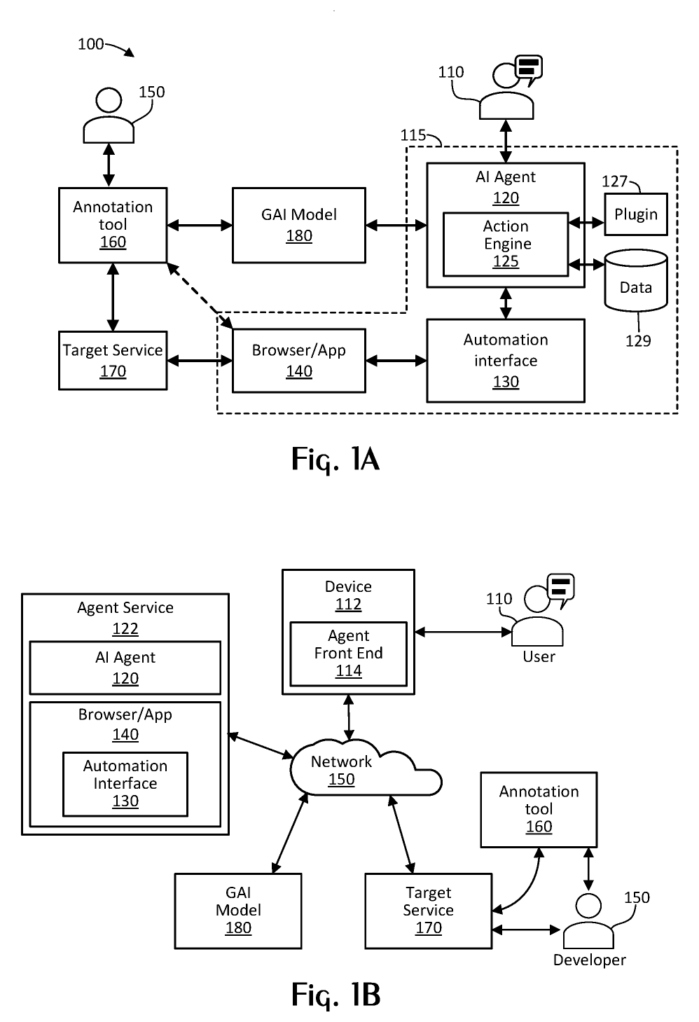

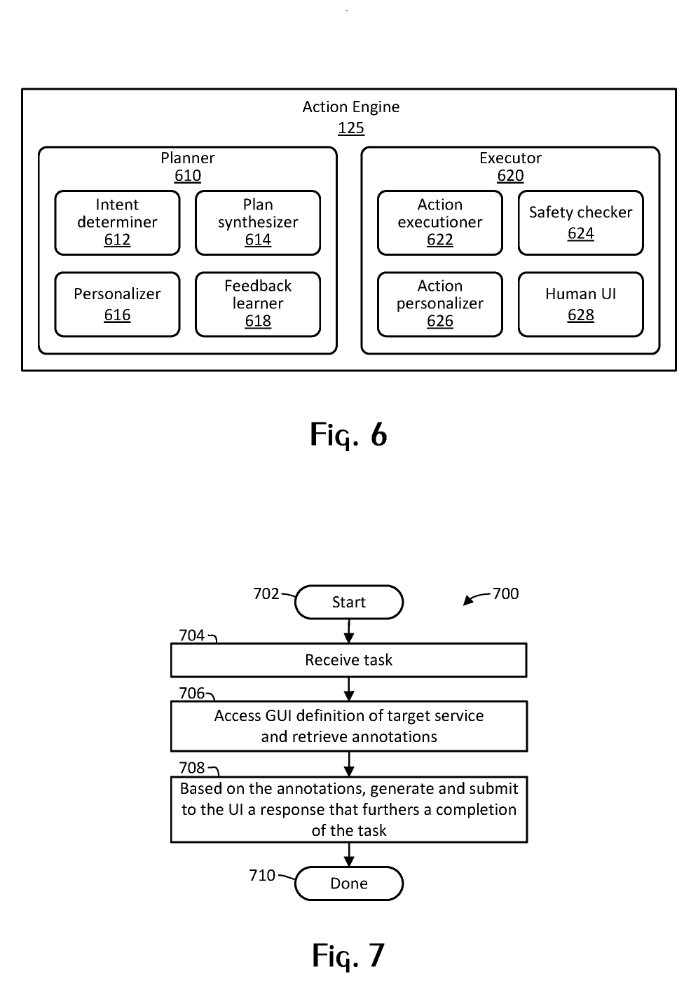

FIG. 1A illustrates by way of example a system 100 for deploying and accessing an AI agent. System 100 includes a user 110 accessing an AI agent 120 comprising an action engine 125 for performing actions requested by user 110. Action engine is described in further detail below with reference to FIG. 6. AI agent 120, in certain example implementations, employs one or more plugins 127 and can store data in database 129. AI agent 120 controls browser/application 140 via automation interface 130. In an example implementation, automation interface 130 is a framework, such as Selenium (available as an open-source project) that interacts with a WebDriver component of popular web browsers. In an alternative implementation, automation interface 130 is a tool for controlling browsers using DevTools protocols. In other examples, other approaches that similarly drive a browser (headless or not) are used. In cases where browser/application 140 is a mobile application, automation interface 130 is implemented as an API or testing framework therefor, as further described below.

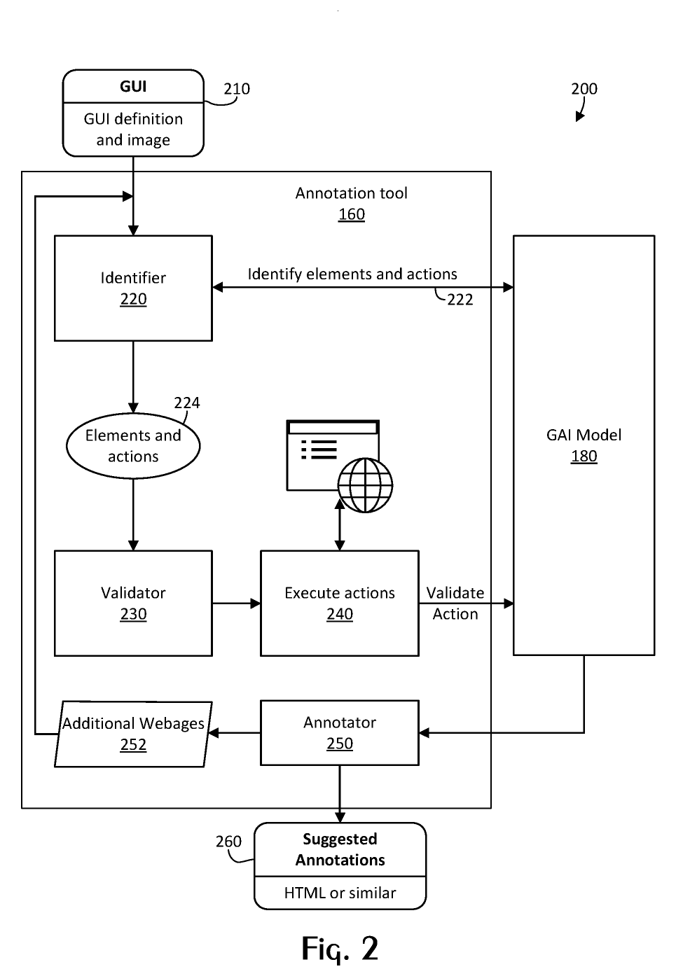

In an example implementation, browser/application 140 is a web browser suitable for accessing a website published by target service 170 (e.g., via the internet). Annotation tool 160 is described in further detail below with reference to FIG. 2 and is used by developer 150 for generating annotations, wherein the annotations enable improved performance by AI agent 120. GAI model 180 guides AI agent 120 in planning actions in response to inputs by user 110 and to annotation tool 160 for generating HTML annotations as further described hereinbelow.

In an alternate implementation, browser/application 140 is a mobile application running on a mobile device operated directly by user 110. In this case, the mobile application communicates with target service 170 via automation interface 130 implemented as an application programming interface (API). In some cases, mobile applications retrieve graphical user interfaces (GUIs) from target service (e.g., in HTML displayed within an embedded browser window within the mobile application). In this case, annotation tool 160 simply annotates GUI generated by target service 170. In other instances, mobile applications are written with internal GUI designs and only retrieve content for the GUI (e.g., text, images, videos, etc.) from target service 170. In this case, annotation tool 160 modifies the mobile application’s GUI by modifying the mobile application itself. The modified mobile application is then provided to the user’s device by downloading it to the device from an application store or the like.

Components 115 are applications, or components thereof, local to user 110 and execute on the user’s device, which in various use cases, is a desktop computer, laptop computer, tablet, mobile phone, etc. Annotation tool 160 is an application or component thereof local to developer 150 or is remotely accessed as a cloud-based service. GAI model 180 and target service 170 are services accessible via the internet or other wide area network. An example implements each of these services as a multitenant service, which comprises a scalable cluster of virtual machines or containerized application instances, across which the compute load is distributed using one or more load balancers. Alternative examples provide one or more services as a unitary, clustered, or microservices application deployed on one or more physical servers. Additional features, included based on implementation but not shown or described herein, include management interfaces, firewall and/or other security mechanisms, etc. Alternative embodiments include services that are subdivided into additional distinct systems with functionality distributed accordingly. Accordingly, the representations of system 100 are presented only as a possible implementation, or as one possible conceptual division of functionality, and should therefore not be considered restrictive.

FIG. 1B illustrates an alternative implementation wherein AI agent 120 is deployed as a centralized service that is remotely accessed. In this case, device 112 is local to user 110 and agent service 122 is deployed in a remote datacenter, e.g., using a public cloud service. Agent service 122 comprises AI agent 120, which includes action engine 125 (not shown in FIG. 1B) as described above with reference to FIG. 1A. In addition, agent service 122, in certain example implementations, includes browser/application 140 and automation interface 130. It may be notable that in FIG. 1B, automation interface 130 is illustrated as a component of browser/application 140, whereas in FIG. 1A, automation interface 130 is illustrated separate from browser/application 140. Either approach is possible and functional blocks, including browser 140 and automation interface 130, should be understood as corresponding to code segments for implementing conceptual functionality that can be combined and/or subdivided depending on implementation details.

Device 112 includes agent front end 114 which receives a request from user 110 and forwards the request to agent service 122. Agent service 122 is a service accessible via the internet or other wide area network as described above with respect to target service 170 and GAI model 180. AI agent 120 and browser 140, and automation interface 130, are, in some example implementations, deployed as a unitary service on a physical server computer. In alternate implementations, AI agent 120 and browser 140 are deployed separately in individual physical server computers and can be deployed as scalable services, e.g., using virtual computing or containerization. In this case, there are multiple instances of AI agent 120 and browser 140 distributed across multiple physical server computers.

Regardless of the deployment model (e.g., as shown in FIGS. 1A or 1B) AI agent 120 receives the request from user 110, obtains a plan therefor from GAI model 180, and then executes the plan via automation interface 130 on browser/application 140. Browser/application 140, when implemented as a browser, accesses a web service published by target servicer 170 which enables the request to be completed according to the plan determined by GAI model 180. Similarly, browser/application 140, when implemented as an application, accesses an API published by target service 170. These interactions are described in more detail below, e.g., with reference to FIGS. 6-8.

FIG. 2 shows a hybrid block diagram and flowchart 200 illustrating by way of example an implementation of annotation tool 160. Annotation tool 160 leverages GAI model 180 to identify each interactive element on GUI 210 and provide suggested annotations 260 that include a natural language description of the interactive element. Interactive elements are components of a GUI that are designed to be interacted with by a user, i.e., that provide a target for user actions. Examples of interactive elements include links and buttons that may be “clicked” using a mouse or “tapped” using a finger on a touch-sensitive screen. Other elements include text boxes into which a user may input text. Some elements are scrollable, e.g., using a mouse-wheel or a swiping gesture. An interactive element can be the viewport of the webpage or GUI, which is scrollable by a user to view additional content generated by the target service. While there are some common GUI conventions that many website and application developers follow (and to which users have become accustomed) any graphical element, such as an icon, image, or design—of any shape or size—can potentially be interacted with by a user. Each interactive element will be associated with one or more actions that can be performed on the interactive element. A non-exhaustive list of actions include clicking, right-clicking, shift-clicking (i.e., clicking the mouse while holding down the shift key on the user’s keyboard), scrolling, tapping, double-finger tapping, triple-finger tapping, swiping, two-finger swiping, three-finger swiping, pinching (i.e., bringing two fingers into contact with the touch-screen and bringing contact points together), stretching (opposite of pinching). Annotating interactive elements within the GUI enables AI agent 120 (FIGS. 1A, 1B) to accurately identify operations without processing the GUI image at runtime to infer purposes of interactive elements.

Within annotation tool 160 are functional blocks including identifier 220, validator 230, execute actions operation 240, and annotator 250. These functional blocks each correspond to a segment of code for performing corresponding operations on behalf of annotation tool 160. It should be understood that the functional blocks each comprise subprocesses that are not separately shown, some of which are shared by multiple functional blocks (at least in certain examples). Accordingly, the functional blocks are one possible way to represent an operation of annotation tool 160, and they could be combined or further divided while still maintaining the overall functionality being described herein. Functional blocks operate synchronously or asynchronously (i.e., in a pipeline configuration). Furthermore, annotation tool 160, in certain embodiments, is deployed as a scalable cloud application with each functional block (or more or fewer functional blocks) being deployed as microservices. In an example implementation, annotation tool 160 is integrated into an integrated development environment (IDE) (not shown) used for developing interactive websites and/or mobile applications. Such an IDE, in alternate implementations, executes on a developer’s desktop computer system (not shown) or remotely, e.g., in a cloud-based IDE.

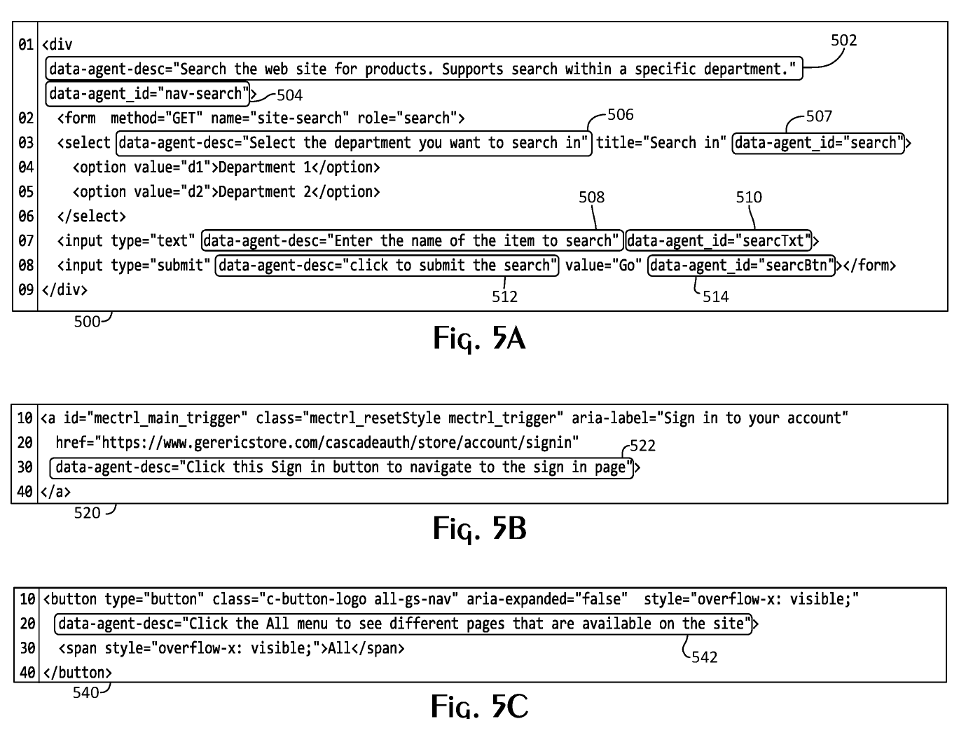

Descriptions below of annotation tool 160 are made with reference to FIGS. 5A-C and 10. In operation, annotation tool 160 integrates with a web browser or an application execution engine (not shown) which retrieves, for example, using an automation interface as previously described, a GUI definition and an image of the GUI generated by the browser or application. The GUI definition comprises HTML source code or an equivalent serialized textual representation of the GUI. Application developers can instrument their existing application to traverse the UI tree to similarly generate a serialized GUI definition via an API for consumption by annotation tool 160 or AI agent 120 as mentioned previously. Application developers can also obtain a GUI definition from an application using development tools to obtain a GUI definition. These tools rely on an underlying infrastructure which can also be directly interacted with to obtain a serialized GUI definition. For purposes herein, a GUI definition (also referred to herein simply as a “GUI definition”) obtained from a website in the form of HTML is functionally equivalent to a serialized GUI definition obtained from an application. Both HTML and mobile applications currently support accessibility annotations or content descriptions which are coded into the application by the developer to assist impaired users (e.g., users with vision impairment). Aspects of the disclosure include means for enhancing HTML and/or application GUIs with annotations specifically to support AI navigation without image processing, as further explained with reference to FIGS. 6-8 below.

Identifier 220 receives the GUI 210 comprising the (unannotated) GUI definition and GUI image and provides these resources via GAI interactions 222 to GAI model 180 with instructions for identifying, within the GUI definition, elements and corresponding actions. The GUI image is a screenshot or image capture of the display generated by the browser or application. This can be done in memory (e.g., by a headless browser) without literally displaying the application or browser interface on a display screen. Certain elements may support multiple different interactions. For example, some elements can only be left-clicked while others can be right-clicked, shift-clicked, etc. Similarly, some interactive elements can only be tapped while others can be tapped, double-tapped, tap-and-hold, and/or dragged, etc. Because GUI definitions do not reliably inform the reader what sorts of GUI interactions are available (e.g., what types of interactions the website or the application will respond to). The possible GUI interactions are inferred by GAI model 180 based on GUI definition as well as the GUI image. In an example, if a web page or mobile application shows a map, the GAI model should infer that the map is scrollable using a two-fingered swipe gesture, since that is a common gesture for scrolling maps in web pages and in mobile application devices.

In an example implementation, GAI model 180 additionally provides, along with its initial inferred actions based on the GUI definition and the GUI image, initial inferred descriptions for each GUI element. As an example, the GAI model would infer that the purpose of a link labeled “home” in both the GUI definition and the GUI image is to enable a user to navigate to the site’s home page. This step is optional since the inferred description can also be obtained in the validation operation described below.

Accordingly, identifier 220 identifies interactive elements and actions 224 which are communicated to validator 230. The interactive elements are communicated to validator 230 as segments of (or locations within) the GUI definition that define the corresponding interactive element. Validator 230 performs automation tests on the interactive elements based on actions received from identifier 220 to generate and/or confirm the validity of descriptions generated by GAI model 180 for each interactive element. Actions are executed in operation 240, wherein an inferred action is tested by navigating to the page where the interactive element is available, performing the action on the interactive element, and then retrieving the GUI definition and the GUI image resulting from the action. In an example, an automation interface for a browser (e.g., similar to automation interface 130 described above with reference to FIGS. 1A and 1B) is used for interacting with the website. In an alternate embodiment, an instrumented application provides an API for securely interfacing with annotation tool 160 through which annotation tool 160 obtains a GUI definition and a GUI image, and to which annotation tool 160 can provide automation inputs to the GUI.

The GUI definition and image taken both before and after execution of the action are sent to GAI model 180 for comparison, to confirm, determine, or update an inferred description of the interactive element. For example, before and after images of a calendar web application after left-clicking an event listed in a calendar, allows GAI model 180 to infer that left-clicking will bring up details of the event while GUI images taken before and after right-clicking will allow GAI model 180 to infer that right-clicking the event will bring up a pop-up menu enabling modifying or deleting the event.

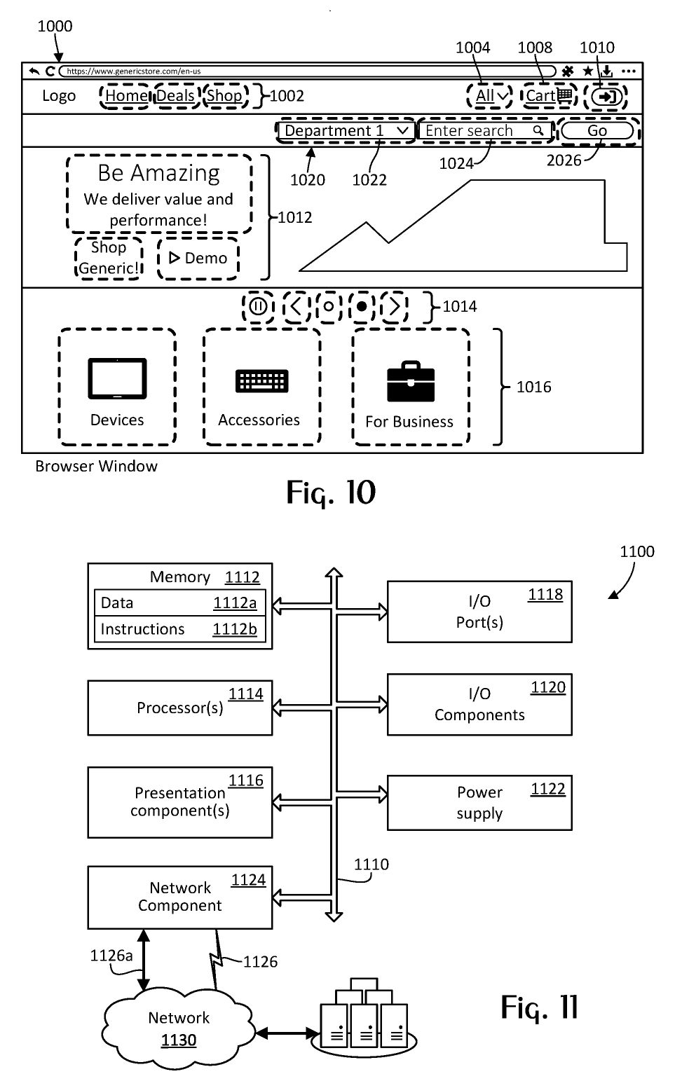

An inferred description is determined or confirmed by GAI model 180 for each interactive element of the GUI, or a subset thereof as determined by developer 150. The inferred description will, in certain instances, include multiple possible actions and the purpose or result obtained by each of the actions, in natural language. In FIG. 10, interactive elements of an example web page are shown encircled with thick dashed lines. Referring to FIG. 10, example annotations for search bar 1020, sign-in button 1010, and “All” menu 1004, are shown in FIGS. 5A, 5B, and 5C, respectively. Annotations are implemented as custom data attributes in HTML and as such are ignored by browsers.

FIG. 5A shows an annotation 502 is directed to a “<div>” element that encompasses search bar 1020. Annotation 502 reads: data-agent-desc=“Search web site for products. supports search within a specific department.” The phrase “data-agent-desc” is a label for the annotation, and the text associated with the label is “Search the web site for products. Supports search within a specific department.” The label designates the custom annotation as an interactive element (or group) description, which GAI model 180 can then interpret as such. This illustrates an annotation for a group of interactive elements. Within the <div> element, three interactive elements are annotated, including drop-down menu 1022 for selecting a department, search box 1024 for entering search text, and GO button 2026 to initiate a search. Annotation 506 describes search box 1024 as “Select the department you want to search in” and annotation 512 describes GO button 2026 as “click to submit the search.”

Similarly, FIG. 5B shows an example annotation 522 for sign-in button 1010, describing the button with “Click this sign in button to navigate to the sign in page.” Finally, FIG. 5C shows an example annotation 542 for ALL link 1004 reading, “Click the All menu to see different pages that are available on the site.”

Returning to FIG. 2, annotator 250 receives annotations from GAI model 180 and generates an output of suggested annotations 260. In one example, suggested annotations 260 comprise annotated HTML and is deployed directly to target service 170. However, because many websites are dynamically generated, incorporating annotations into a web page may require modifying back-end code (e.g., in Python, Ruby, Java, Node.js, PHP, C#, Go, etc.) that is used to generate the HTML. In an example implementation, annotation tool 160 is integrated into a web IDE, and displays a live preview of the user interface that is capable of highlighting interactive elements and displaying an annotation upon mouse-over of the corresponding interactive element. The IDE also enables simple editing by developer 150 of the annotation. Similarly, interactive elements of a GUI generated by a mobile application (as opposed to a website) are annotated via the IDE based on suggested annotations 260 provided by tool 160.

A website is a collection of web pages that belong to the same domain or closely associated domains (e.g., by being commonly owned). By way of example, a website is crawled by following links that direct to other web pages of the website. Website crawling is a well-developed technology often used by web search engines. Annotation tool 160 identifies additional webpages 252 either using a previously prepared list of web pages generated by an adjunct web crawler (not shown) or by identifying links internally during or concomitant to the annotation. If additional webpages 252 are present (e.g., additional links that direct to as-yet unannotated web pages) then the procedure returns to identifier 220 wherein the net web page is processed for annotation.

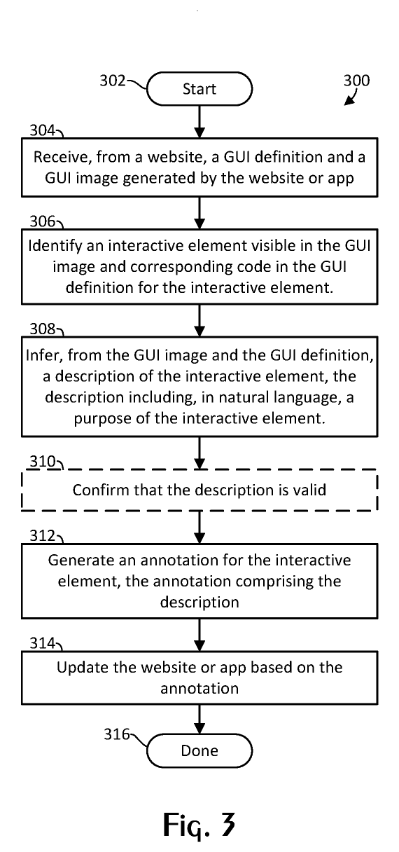

FIG. 3 shows a flowchart illustrating by way of example a procedure 300 performed by annotation tool 160, for generating annotations for interactive GUI elements based on a GUI image and GUI definition and applying those annotations within a website or application. Procedure 300 comprises operations that in alternate implementations are combined and/or supplemented with additional operations, or are performed in an order other than that shown unless logic dictates otherwise. Procedure 300 begins at start 302 and proceeds to operation 304, wherein annotation tool receives, from a website or application, an unannotated GUI definition and a GUI image. It should be understood that, in the case of a website, the GUI definition and GUI image are, in certain examples, obtained by a browser, such as a headless browser, based on interactions with the website, and as such they need not be received directly from the website. The unannotated GUI definition may include source code, markup, or other programmatic representations of GUI elements, while the GUI image provides a visual representation of the interface.

At operation 306, procedure 300 identifies an interactive element that is visible in the GUI image and locates corresponding code for the interactive element within the unannotated GUI definition. Interactive elements may include buttons, links, sliders, input fields, or any other UI components capable of receiving user interaction. At operation 308, annotation tool 160, infers, using GAI model 180, a description of the interactive element based on the GUI image and GUI definition. The inferred description is expressed in natural language and includes an explanation of the purpose or function of the interactive element within the GUI context. At optional operation 310, the procedure validates the accuracy of the inferred description. This validation may be performed manually by a user or automatically as described above with reference to FIG. 2. At operation 312, procedure 300 generates an annotation for the interactive element. The annotation includes the natural language description inferred in operation 306 and stored in association with the element or within a metadata structure.

At operation 314, procedure 300 updates the website or application based on the generated annotation. The annotation is consumed thereafter by AI agent 120 as previously described and further described in detail below. Procedure 300 concludes with block 316.

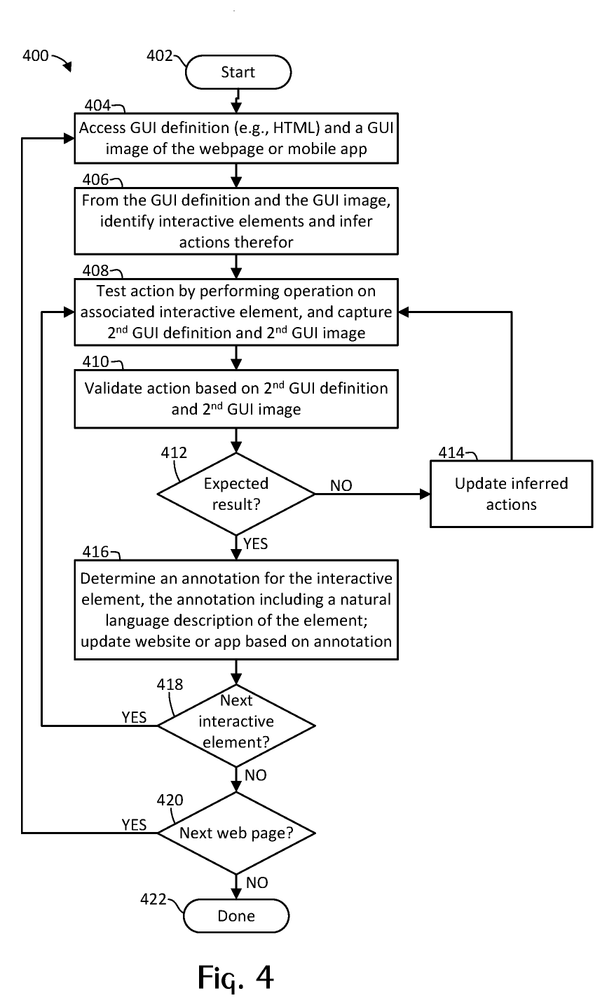

FIG. 4 shows a flowchart that illustrates way of example a more detailed procedure 400 for testing inferred actions associated with interactive elements on a web page and generating corresponding annotations to update the web page accordingly. Procedure 400 is implemented by annotation tool 160 described above with reference to FIG. 2 and comprises operations that, in alternate implementations, are combined and/or supplemented with additional operations, or performed in an order other than that shown unless logic dictates otherwise.

The procedure begins at operation 402, where execution is initiated. In operation 404, an unannotated GUI definition (e.g., HTML or similar structured code defining a GUI) and a GUI image of a web page or a screen of a mobile application are accessed. The GUI image provides a visual representation of the GUI, while the GUI definition provides the underlying structural or programmatic data. In operation 406, the procedure identifies one or more interactive elements from the unannotated GUI definition and GUI image and infers possible user actions associated with each interactive element as described above with reference to FIG. 2.

In operation 408, a selected inferred action is tested by performing the inferred action on the corresponding interactive element. Following this, a second unannotated GUI definition and a second GUI image are captured, representing the updated state of the interface. In operation 410, the procedure validates whether the tested action produced the expected result by analyzing the second GUI definition and the second GUI image. In operation 412, a determination is made as to whether the expected result was achieved. If not (branch NO), the procedure proceeds to operation 414, where the inferred actions are updated or refined. The procedure then returns to operation 408 to re-test the revised action.

In an alternate embodiment (not shown in FIG. 4) rather than determining if the result is expected, the before and after GUI definition and image are compared to identify a description of the interactive element, for example, by determining, using GAI model 180, what result the action achieves.

If the expected result is confirmed (branch YES), the procedure proceeds to operation 416, in which an annotation is determined for the interactive element. The annotation includes a natural language description of the element or its function. The website or application is updated in accordance with the annotation.

In operation 418, the procedure determines whether there are additional interactive elements to process on the current page. If so (branch YES), the procedure returns to operation 408. If no further elements remain (branch NO), the procedure proceeds to operation 420, where it is determined whether another web page or application view remains to be analyzed. If so (branch YES), the procedure returns to operation 404. If no further web pages or views remain (branch NO), the procedure concludes at operation 422.

FIGS. 5A, 5B, and 5C illustrate example annotations corresponding to interactive elements shown in the example website shown in FIG. 10. Annotation 500 in FIG. 5A illustrates annotations providing descriptions and identifiers for a group of interactive elements encompassed by a <div> tag, and descriptions and identifiers for individual interactive elements (buttons and links). Annotations 502, 506, 508, and 512 are description annotations using the custom annotation identifier “data-agent-desc.” As a custom annotation, these are permitted by HTML convention but ignored by browsers. Annotations 504, 507, 510, and 514 are identifier annotations using the custom annotation identifier “data-agent-id” which allows AI agent 120 to uniquely identify each interactive element, as well as each group of interactive elements, which includes annotations. In certain embodiments, applying annotation identifiers to interactive elements and groups of interactive elements is useful for associating the visual representation of the interactive element as displayed in the GUI with a location within the GUI definition for the interactive element. The annotation identifier is also useful to enable developer 150 to distinguish between different interactive elements when viewing the source code for the website or application.

FIGS. 5B and 5C show annotations 522 and 542, respectively as previously described above with reference to FIG. 2.

FIG. 6 shows a block diagram illustrating, by way of example, architecture of action engine 125. An action engine is a system that can automatically execute complex tasks on existing websites and applications based on natural language descriptions thereof from the user. For example, the user might request AI agent 120 to “download all my bank statements from last year.” The action engine interprets the user’s intent and uses one or more GAI models, AI agents, or tools to accomplish the task. To accomplish a complex task, action engine breaks it down into a sequence of actions and performs them on relevant websites and applications, either by interacting with their user interfaces (UIs) or underlying application programming interfaces (APIs), or by employing external domain-specific agents and tools. In certain implementations and scenarios, the action engine requires minimal user interaction to handle tasks beyond its capabilities, such as solving a captcha or obtaining additional information about that task that is not included in the initial task description, to deal with system exceptions when the output is unexpected or task progress is slow, or to give users more control over the action engine’s operation (e.g., the specific website, application, or tool it uses to make task progress).

Action engine 125 includes planner 610 and executor 620. As illustrated in FIG. 6, planner 610 and executor 620 each include a number of modules which are represented as functional blocks. Functional blocks correspond to segments of code which may be implemented in numerous ways as previously explained with reference to FIGS. 1A and 1B above. Planner 610 receives the task the user wants to complete as input and generates, using plan synthesizer 614, a plan of actions that are required to complete the task. Planner 610 may, using personalizer 616, use the user’s profile, preferences, and task history of completed tasks, and leverage foundation models or specialized planning algorithms. For instance, a user may ask the action engine to “renew all checked-out library books for one more month.” The action engine then creates a plan of actions that includes (1) opening the user’s default library website (found from the user’s profile), (2) logging in if necessary and if the user has given login consent, (3) navigating to the “checked-out books” section of the website, (4) selecting all books, (5) clicking on the “renew” button, and finally (6) verifying that the final page contains the confirmation text “all books renewed.”

Executor 620 carries out each step in the action plan by interacting with the target application or website UI or underlying APIs. In an example implementation, executor 620 leverages foundation models to determine how to perform an action. In an example, to execute the action “click the ’renew’ button,” the executor uses a GAI model to locate the target button on the current website screen. Executor uses the user’s profile and preferences (e.g., to log in to their account or to choose an option), external tools, or even other AI agents. For example, if the library website has an AI agent that can do the renewal task, action engine 125 might interact with it to perform the task. Planner 610 and executor 620 work together: the planner generates a few steps that the executor performs. Based on the outcome of these steps, planner 610, in certain scenarios, will generate more steps for executor 620. The loop, in certain examples, also includes the user via Human UI 628, for example, to clarify the user’s intent, to handle exceptions, to help the agent perform new tasks, or to complete a complex task with human-agent collaboration. Human inputs and feedback are, for example implementations, leveraged to fine-tune or retrain the foundation model to improve its accuracy using feedback learner 618.

In example implementations, action engine 125 utilizes existing APIs to perform tasks, but APIs are not mandatory for task execution. A significant advantage this design is that the action engine can accomplish tasks by interpreting and interacting with application or website user interfaces designed for human interaction. The strong emphasis on safely and robustly performing these actions at Web scale is what differs action engines from typical AI assistants, which often target specific domains or select websites.

While existing technology, such as GAI models and Web automation frameworks (e.g., Playwright), are leveraged to build planner 610 and the executor 620, modifications are made to overcome technical challenges of the existing technology. For example, planner 610 infers the user’s implicit and explicit intent, asks the user for any missing or disambiguating information, and uses the user’s profile, preferences, and task history to generate a complete or partial action plan. To generate the plan, the planner understands the set of possible actions, as well as their semantics, which can be performed on different websites or applications. The plan is accurate and safe, meaning that it not only achieves the user’s goal, but also avoids any unintended side-effects. Safety checker 624 ensures safety by applying semantic or heuristic rules to actions and generating exceptions or user confirmations for certain actions. In examples, the plan is personalized using personalizer 616 as previously mentioned, by taking into account the user’s long-term and short-term interests, as well as the user’s feedback and behavior over time. For example, personalizer 616 maps the identified intents from intent determiner 612 to task plans of other users with similar interests and preferences, and then refines the plan based on the individual user’s characteristics and preferences.

Executor 620 performs each step of the plan by identifying the correct interaction target (e.g., UI control, API, tool, or agent) and verifies that each action is performed as expected. Action executioner 622 ensures that the task execution is safe, reliable, secure, and personalized, via safety checker 624 and action personalizer 626. In certain implementations, speed is emphasized depending on the task and the circumstances. It should also be able to involve humans via human UI 628 for any critical steps, such as unblocking an operation with a login or providing additional information. Feedback learner 618 improves planner 610 and executor 620 over time, improving based on their experiences and feedback across multiple websites or applications, and improving their performance and robustness. Reinforcement learning can be useful here, using, for example, task outcome as the reward function.

In some examples, an agents.txt file listing the actions supported by a website is hosted in the root directory of the site.

FIG. 7 illustrates an example procedure 700 performed by AI agent 120, wherein the agent utilizes annotations embedded within the GUI of a website or application to assist in completing a task. The procedure begins at operation 702, where the AI agent initiates execution. In operation 704, AI agent 120 receives a task. The task may be provided by a user, another software system, or a task scheduling component, and may specify an objective to be accomplished through interaction with a particular GUI associated with target service 170.

In operation 706, AI agent 120 accesses the GUI of a target service such as via a web application or mobile application. In an example, the GUI is retrieved as a textual definition of the GUI such as HTML markup or other textual or serialized GUI definition as described above. In doing so, AI agent 120 retrieves annotations that have been incorporated into the GUI definition. Each annotation is a natural language description of the individual interactive element and includes a purpose of the corresponding interactive element, i.e., what result is achieved by interacting with the interactive element.

In operation 708, based on the retrieved annotations, the AI agent 120 generates and submits a response to the GUI. The response is directed toward furthering the completion of the assigned task, and by way of example, includes simulating user input, selecting options, submitting forms, or triggering other interactive elements within the interface. The procedure concludes at operation 710.

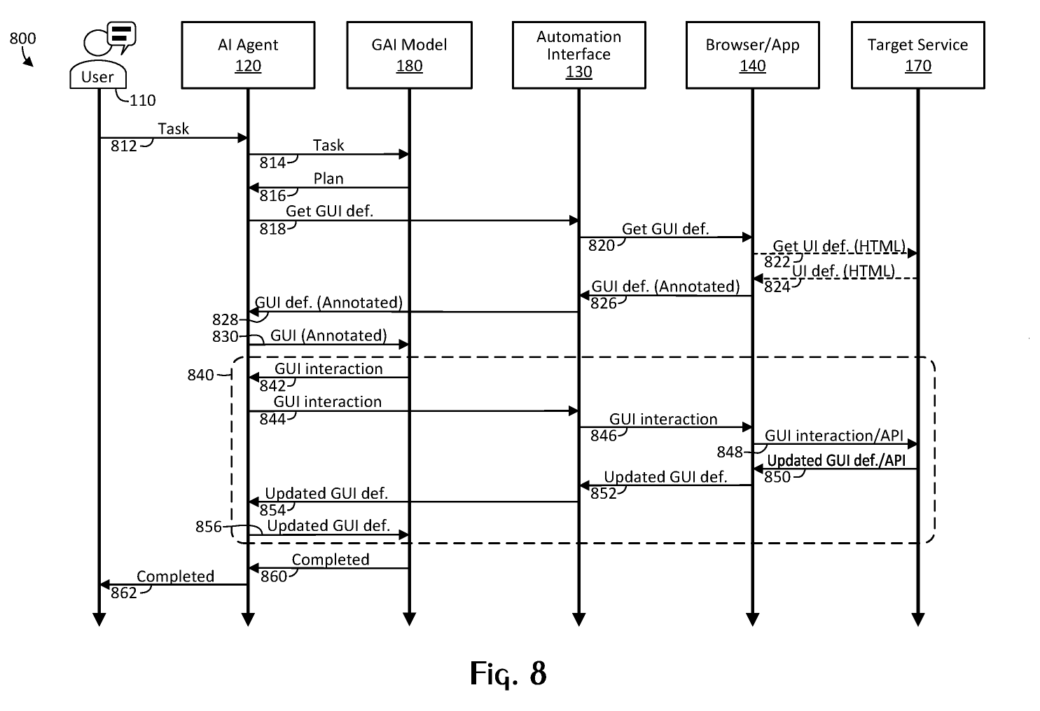

FIG. 8 is a time-space diagram illustrating by way of example a communication sequence 800 among various system entities involved in performing a task using annotated GUI information. The entities are shown along the horizontal axis and include user 110, AI agent 120, GAI model 180, automation interface 130, browser or application 140, and target service 170. Vertical lines extending downward from each entity indicate the temporal progression of actions performed by each respective entity. Horizontal arrows represent messages exchanged between the entities, with message direction indicating the sender and recipient.

The process begins when a user provides a task to the AI agent 120 in message 812. The task is provided in spoken or written natural language. In response, AI agent 120 relays the task to GAI model 180 via message 814. GAI model, in response to message 814, provides a plan 816 to AI agent 120. The plan comprises one or more actions performed on a GUI (e.g., as shown in FIG. 10) associated with target service 170.

In an example implementation, plan 816 instructs AI agent 120 to navigate to a particular website provided by target service 170. In this case, plan 816 may include a uniform resource locator (URL) of a target website and instruct AI agent 120 to retrieve the HTML from that website and provide that HTML to GAI model 180 for further analysis and additional actions. In alternate examples, the plan includes multiple steps such as performing multiple operations on a GUI, of a website or an application, which the GAI model already understands without having to first retrieve the GUI definition (such as HTML code).

In response to plan 816, the AI agent 120 issues message 818 to automation interface 130, instructing automation interface 130 to retrieve the GUI definition associated with the target service 170 as instructed by GAI model 180. In an example implementation where browser/application 140 is an application, automation interface 130 is an API exposed by the application or some automation interface ancillary thereto.

In response to receiving message 818, automation interface 130 transmits a request 820 to the Browser/Application 140 to retrieve the GUI definition. If browser/application is a web browser, request 820 may be implemented as a request to navigate to a target URL and retrieve the HTML therefrom. In response, browser/application 140 (as a browser) issues a GET (message 822) to the URL of the target service 170 (a web server) and retrieves the HTML from the target website via message 824.

If browser/application is an application, request 820, in scenarios as described herein, comprises instructions to the application’s API or automation interface to retrieve a GUI definition of the current GUI display. Where the GUI is locally generated, there will not be any interaction with target service 170 since the application will simply return the GUI definition of its current state.

In message 826, browser/application 140 forwards the GUI definition to automation interface which forwards the GUI definition in message 828 to AI agent 120. In response to receiving GUI definition in message 828, AI agent 120 forwards the GUI definition to GAI model 180 in message 830 for task planning and interpretation. Because the GUI definition is annotated with description of interactive elements, there is no need for GAI model 180 to obtain or analyze an image of the GUI to determine the purpose of the different interactive elements.

Communications 840 indicated by a dashed line highlights a loop of interactions that are, in certain implementations and/or scenarios, performed iteratively or according to a task execution plan determined by the AI agent. This loop includes messages 842-856. Message 842 from GAI model 180 to AI agent 120 instructs AI agent 120 to perform an action in furtherance of the task. The instruction could also include multiple actions in sequence, and not a single action. AI agent 120 interprets this instruction and forwards a GUI interaction instruction 844 to automation interface 130. Automation interface 130 converts this to an instruction understandable by browser/application 140 in message 846.

If browser/application is a web browser, then messages 848 and 850 comprise communications between the browser and a web server made available by target service 170 and messages 848 and 850 comprise hypertext transfer protocol (HTTP) messages such as GET, POST messages and responses thereto. If browser/application is an application, then messages 848 and 850 can comport to any standardized or non-standard API protocol as implemented by the application and target service 170. In any case, this interaction results in an updated GUI made available to or generated by (or some combination thereof) browser/application 140. Browser/application 140 then forwards, in message 852, the updated GUI definition to automation interface 130 which relays the updated GUI definition to AI agent 120 via message 854 which then forwards the updated GUI definition to GAI model 180.

Communications 840 are repeated as necessary until the task is complete, whereupon GAI model indicates completion in message 860 to AI agent 120, which then informs user 110 that the task is complete in message 862 (e.g., by displaying a complete message or icon).

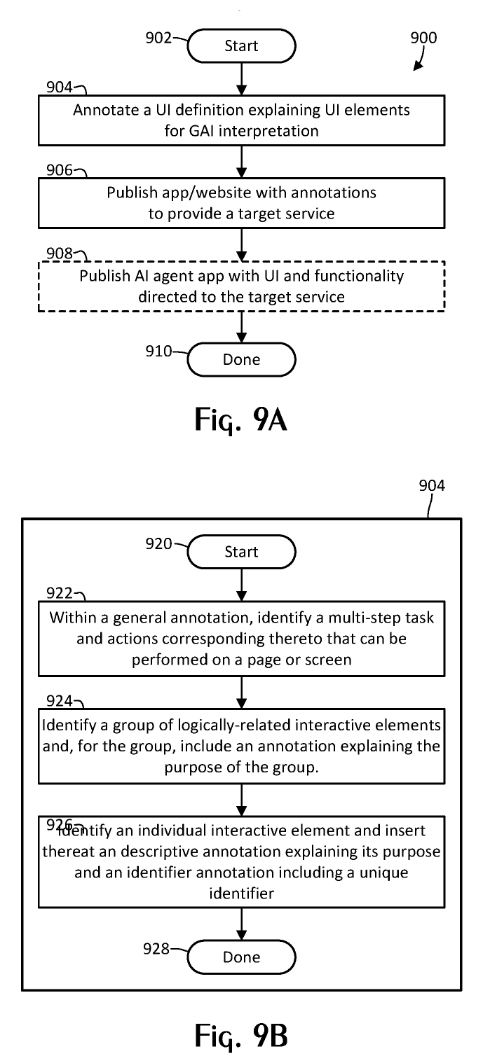

FIGS. 9A and 9B show flowcharts illustrating by way of example a procedure 900 that may be performed by a service provider to enable an AI agent to interact with a user-facing application or website. Procedure 900 facilitates interpretation and execution of user tasks using a GAI model and a GUI exposed by a target service provided by the service provider.

Referring to FIG. 9A, the procedure 900 begins at operation 902, which denotes the start of the process. At operation 904, a UI definition is annotated to explain the UI elements for GAI interpretation. This annotation includes textual labels that help the AI system understand the semantics and intended purpose of various UI components.

At operation 906, the application or website is published with the aforementioned annotations, providing a target service accessible to users. The annotations included at this stage enable subsequent AI interpretation and interaction.

Optionally, in operation 908, an AI agent application is published with a UI and functionality directed to the target service. This AI agent application may use the annotations to perform tasks on behalf of users by interpreting user goals and interacting with the annotated interface programmatically or via natural language commands. Operation 908 is shown in dashed lines to indicate that it is an optional component of the procedure. It is envisioned that service providers will be able to deploy an AI agent very simply with this procedure compared to existing methods. A software development kit (SDK) can be provided to service providers to add a branded wrapper to their application or to a browser that provides a chat-based user interface to receive task instructions from the user. Annotated GUIs provide an integrated GAI model with pre-defined inferred descriptions of the important interactive elements of the exposed GUI, enabling the GAI model to accurately construct and execute a plan for completing the received task.

The procedure ends at operation 910, which denotes completion of the process.

FIG. 9B provides a more detailed breakdown of operation 904 from FIG. 9A. This sub-procedure also begins at operation 920, indicating the start of the annotation process. In some scenarios, a web page or UI screen will enable tasks that require multiple operations on a single screen. At operation 922, multi-step tasks that can be performed on a given page are identified. These can be manually encoded for each site, listing common multistep tasks that can be performed on the site. For example, a multi-step task might be to purchase an item. To the extent that the site has any unusual features or functionality, the task for purchasing a particular item can be described in the multi-step task description. Thus, for each multi-step task, a general annotation is created describing the steps to be taken by the AI agent to perform the task.

At operation 924, a group of logically related interactive GUI elements is identified. For each such group, an annotation is included that explains the purpose of the group. Group-level annotations help the AI system contextualize and associate related interface components. This is described above with reference to FIGS. 2 and 10, wherein the search bar is identified as a logically related group of interactive elements.

At operation 926, individual interactive elements are identified. For each individual element, a description annotation is added to explain its purpose, and an identifier annotation is added to assign a unique identifier. These annotations allow the AI agent to locate and interact with specific UI elements precisely. The annotation procedure ends at operation 928, marking completion of the UI annotation process.

FIG. 10 shows a browser window 1000 showing an example web page generated by “Generic Store.” Highlighted by dashed lines are interactive elements including links 1002 in the header, along with all menu link 1004, cart link 1008, and sign-in button 1010.

Additional interactive elements on web page shown in browser window 1000 include links 1012 and 1016, and animation controls 1014. Annotation tool 160 identifies these interactive elements and generates annotations therefor as previously described.

### Additional Examples

An example computer system comprises a processor and a memory storing instructions operative upon execution by the processor to: receive, from a website or application, a graphical user interface (GUI) definition and a GUI image associated with the website or application; identify an interactive element in the GUI image, and corresponding code in the GUI definition for the interactive element; infer, from the GUI image and the GUI definition, a description of the interactive element, the description including, in natural language, a purpose of the interactive element; generate an annotation for the interactive element, the annotation comprising the description; and update the website or application based on the annotation.

Alternatively, or in addition to the other examples described herein, examples include any combination of the following:

Wherein the inferring of the description comprises providing the GUI image and the GUI definition to a generative artificial intelligence (GAI) model, and obtaining the description from the GAI model for the interactive element.

Wherein the instructions are integrated into a web integrated development environment (IDE).

Wherein the instructions are further operative upon execution by the processor to:
validate the description, the validation comprising: executing an action on the interactive element; receiving an updated GUI image and an updated GUI definition resulting from the executing of the action; and confirming that the updated GUI image and the updated GUI definition are consistent with an expected result based on the description.

Wherein confirming that the updated GUI image and the updated GUI definition are consistent with the expected result based on the description comprises providing the updated GUI image and the updated GUI definition to a generative artificial intelligence (GAI) model and obtaining a determination from the GAI model that the updated GUI image and the updated GUI definition comport with the description.

An example computerized method of deploying an artificial intelligence (AI) agent for interacting with a target service on behalf of a user, the method comprising: adding an annotation to a website or application, the annotation comprising, for an interactive element of a graphical user interface (GUI) generated by the website or application, a description of the interactive element; and deploying, for use by the user, an AI agent configured to: receive, from the user, a task description, and providing the task description to a generative artificial intelligence (GAI) model; receive, from the GAI model, a plan for completing the task, the plan comprising an action associated with the GUI generated by the website or application; receive, from the website or application, a GUI definition corresponding to the GUI generated by the website or application, the GUI comprising the interactive element, the GUI definition being in declarative textual form and including the annotation for the interactive element, the annotation including a tag indicating that the annotation provides a description of a purpose of the interactive element and a text string describing the purpose of the interactive element; provide the GUI definition to the GAI model; receive, from the GAI model, the action to be performed on the interactive element of the GUI, the action being based on the annotation and the task description; and transmit, to a browser or the application, an instruction to perform the action.

Alternatively, or in addition to the other examples described herein, examples include any combination of the following:

Wherein the method further comprises: receive, from the website or application, an updated GUI definition; provide the updated GUI definition to the GAI model; receive, from the GAI model, information regarding the task, the information regarding the task being based on the updated GUI definition; and provide the information regarding the task to the user.

Wherein the annotating of the website or application comprises: receiving, from the website or application, an unannotated GUI definition and a GUI image generated by the website or application; identify the interactive element visible in the GUI image and corresponding code for the interactive element in the unannotated GUI definition; obtain from the GAI model, based on the GUI image and the unannotated GUI definition, the description of the interactive element; generate an annotation for the interactive element, the annotation comprising the description; and updating the website or application based on the annotation.

Wherein annotating of the website or application is performed using software integrated into a web integrated development environment (IDE).

Wherein the annotating further comprises identifying a group of logically related interactive elements and annotating the group with an annotation explaining in natural language the purpose of the group.

Wherein the annotating of the website or application further comprises: validating the description, the validating comprising: executing a validation action on the interactive element; receiving an updated GUI image and an updated unannotated GUI definition resulting from the executing of the validation action; and confirming that the updated GUI image and the updated unannotated GUI definition are consistent with an expected result based on the description.

Wherein confirming that the updated GUI image and the updated GUI definition are consistent with the expected result based on the description comprises providing the updated GUI image and the updated GUI definition to the GAI model and obtaining a determination from the GAI model that the updated GUI image and the updated GUI definition comport with the description.

Wherein the inferring of the description comprises providing the GUI image and the unannotated GUI definition to the GAI model and obtaining the description from the GAI model for the interactive element.

Wherein the website or application is a website, and the receiving of the GUI definition comprises requesting, from an automation interface associated with a browser, hypertext markup language (HTML) code of the website.

Wherein the method further comprises providing to the GAI model, personalization data associated with the user, the personalization data comprising at least one of information pertaining to a profile associated with the user, information pertaining to preferences associated with the user, and information pertaining to a history of tasks completed on behalf of the user, wherein the plan is based on the personalization data.

An example computer-readable storage medium stores instructions executable by a processing apparatus to perform operations comprising: receiving, from a website or application, a graphical user interface (GUI) definition and a GUI image associated with the website or application; identifying an interactive element visible in the GUI image and corresponding code in the GUI definition for the interactive element; inferring, from the GUI image and the GUI definition, a description of the interactive element, the description including, in natural language, a purpose of the interactive element; generating an annotation for the interactive element, the annotation comprising the description; and updating the website or application based on the annotation.

Wherein the instructions are integrated into a web integrated development environment (IDE).

Wherein the instructions are further operative upon execution by the processing apparatus to: validate the description, the validation comprising: executing an action on the interactive element; receiving an updated GUI image and an updated GUI definition resulting from the executing of the action; and confirming that the updated GUI image and the updated GUI definition are consistent with an expected result based on the description.

Wherein confirming that the updated GUI image and the updated GUI definition are consistent with the expected result based on the description comprises providing the updated GUI image and the updated GUI definition to a generative artificial intelligence (GAI) model and obtaining a determination from the GAI model that the updated GUI image and the updated GUI definition comport with the description.

Wherein the inferring of the description comprises providing the GUI image and the GUI definition to a generative artificial intelligence (GAI) model and obtaining the description from the GAI model for the interactive element.

### Example Operating Environment

FIG. 11 is a block diagram of an example computing device 1100 (e.g., a computer storage device) for implementing aspects disclosed herein, and is designated generally as computing device 1100. In some examples, one or more computing devices 1100 are provided for an on-premises computing solution. In some examples, one or more computing devices 1100 are provided as a cloud computing solution. In some examples, a combination of on-premises and cloud computing solutions are used. Computing device 1100 is but one example of a suitable computing environment and is not intended to suggest any limitation as to the scope of use or functionality of the examples disclosed herein, whether used singly or as part of a larger set.

Neither should computing device 1100 be interpreted as having any dependency or requirement relating to any one or combination of components/modules illustrated. The examples disclosed herein can be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples can be practiced in a variety of system configurations, including personal computers, laptops, smart phones, mobile tablets, hand-held devices, consumer electronics, specialty computing devices, etc. The disclosed examples can also be practiced in distributed computing environments when tasks are performed by remote-processing devices that are linked through a communications network.

Computing device 1100 includes a bus 1110 that directly or indirectly couples the following devices: computer storage memory 1112, one or more processors 1114, one or more presentation components 1116, input/output (I/O) ports 1118, I/O components 1120, a power supply 1122, and a network component 1124. While computing device 1100 is depicted as a seemingly single device, multiple computing devices 1100 can work together and share the depicted device resources. For example, memory 1112 is distributed across multiple devices, and processor(s) 1114 is housed with different devices.

Bus 1110 represents one or more busses (such as an address bus, data bus, or a combination thereof). Although the various blocks of FIG. 11 are shown with lines for the sake of clarity, delineating various components can be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 11 and the references herein to a “computing device.” Memory 1112 can take the form of the computer storage media referenced below and operatively provide storage of computer-readable instructions, data structures, program modules and other data for the computing device 1100. In some examples, memory 1112 stores one or more of an operating system, a universal application platform, or other program modules and program data. Memory 1112 is thus able to store and access data 1112a and instructions 1112b that are executable by processor 1114 and configured to carry out the various operations disclosed herein.

In some examples, memory 1112 includes computer storage media. Memory 1112 can include any quantity of memory associated with or accessible by the computing device 1100. Memory 1112 can be internal to the computing device 1100 (as shown in FIG. 11), external to the computing device 1100 (not shown), or both (not shown). Additionally, or alternatively, the memory 1112 can be distributed across multiple computing devices 1100, for example, in a virtualized environment in which instruction processing is carried out on multiple computing devices 1100. For the purposes of this disclosure, “computer storage media,” “computer-storage memory,” “memory,” and “memory devices” are synonymous terms for the computer-storage memory 11012, and none of these terms include carrier waves or propagating signaling.

Processor(s) 1114 includes any quantity of processing units that read data from various entities, such as memory 1112 or I/O components 1120. Specifically, processor(s) 1114 are programmed to execute computer-executable instructions for implementing aspects of the disclosure. The instructions can be performed by the processor, by multiple processors within the computing device 1100, or by a processor external to the client computing device 1100. In some examples, the processor(s) 1114 are programmed to execute instructions such as those illustrated in the flow charts discussed below and depicted in the accompanying drawings. Moreover, in some examples, the processor(s) 1114 represent an implementation of analog techniques to perform the operations described herein. For example, the operations are performed by an analog client computing device 1100 and/or a digital client computing device 1100. Presentation component(s) 1116 present data indications to a user or other device. Exemplary presentation components include a display device, speaker, printing component, vibrating component, etc. It should be understood that computer data can be presented in a number of ways, such as visually in a graphical user interface (GUI), audibly through speakers, wirelessly between computing devices 1100, across a wired connection, or in other ways. I/O ports 1118 allow computing device 1100 to be logically coupled to other devices including I/O components 1120, some of which can be built in. Example I/O components 1120 include, for example but without limitation, a microphone, joystick, game pad, satellite dish, scanner, printer, wireless device, etc.

Computing device 1100 can operate in a networked environment via the network component 1124 using logical connections to one or more remote computers. In some examples, the network component 1124 includes a network interface card and/or computer-executable instructions (e.g., a driver) for operating the network interface card. Communication between the computing device 1100 and other devices can use any protocol or mechanism over any wired or wireless connection. In some examples, network component 1124 is operable to communicate data over public, private, or hybrid (public and private) using a transfer protocol, between devices wirelessly using short range communication technologies (e.g., near-field communication (NFC), Bluetooth^{TM} branded communications, or the like), or a combination thereof. Network component 1124 communicates over wireless communication link 1126 and/or a wired communication link 1126a to a remote resource 1128 (e.g., a cloud resource) across network 1130. Various different examples of communication links 1126 and 1126a include a wireless connection, a wired connection, and/or a dedicated link, and in some examples, at least a portion is routed through the internet.

Although described in connection with an example computing device 1100, examples of the disclosure are capable of implementation with numerous other general-purpose or special-purpose computing system environments, configurations, or devices. Examples of well-known computing systems, environments, and/or configurations that suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality devices, holographic device, and the like. Such systems or devices might accept input from the user in any way, including from input devices such as a keyboard or pointing device, via gesture input, proximity input (such as by hovering), and/or via voice input.

For simplicity and illustrative purposes, principles presented herein are described in reference to embodiments and examples thereof. In the following description, numerous specific details are set forth in order to provide an understanding of the embodiments and examples. It should be understood, however, that the embodiments and examples may be practiced without limitation to these specific details. In some instances, well-known methods and/or structures have not been described in detail so as not to unnecessarily obscure the description of the embodiments and examples. Furthermore, the embodiments and examples may be used together in various combinations.

References herein to “one embodiment,” “an embodiment,” “an example implementation,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

The terms “a” and “an” are intended to denote at least one of a particular element. As used herein, the term “includes” means includes but not limited to, the term “including” means “including but not limited to.”

Examples are described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform particular tasks or implement particular abstract data types. Aspects of the disclosure can be implemented with any number and organization of such components or modules. For example, aspects of the disclosure are not limited to the specific computer-executable instructions or the specific components or modules illustrated in the figures and described herein. Other examples of the disclosure include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium for storing information for access by a computing device. In contrast, communication media typically embody computer readable instructions, data structures, program modules, or the like in a modulated data signal such as a carrier wave or other transport mechanism and include any information delivery media.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

In examples involving a general-purpose computer, aspects of the disclosure transform the general-purpose computer into a special-purpose computing device when configured to execute the instructions described herein.

It will be understood that the benefits and advantages described above can relate to one embodiment or to several embodiments. The embodiments are not limited to those that solve any or all of the stated problems or those that have any or all of the stated benefits and advantages. It will further be understood that reference to ‘an’ item refers to one or more of those items.

The term “comprising” is used in this specification to mean including the feature(s) or act(s) followed thereafter, without excluding the presence of one or more additional features or acts.

In some examples, the operations illustrated in the figures are implemented as software instructions encoded on a computer storage medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing a particular operation before, contemporaneously with, or after another operation is within the scope of aspects of the disclosure.

As used herein, the term “set” is non-empty, and can also be referred to as a “group.”

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there might be additional elements other than the listed elements. The term “exemplary” is intended to mean “an example of.” The phrase “one or more of the following: A, B, and C” means “at least one of A and/or at least one of B and/or at least one of C.”

Below are specific example implementations offered here without limitation:

While the aspects of the disclosure have been described in terms of various examples with their associated operations, a person skilled in the art would appreciate that a combination of operations from any number of different examples is also within scope of the aspects of the disclosure.

What is claimed is:

1. A computer system comprising:
a processor; and
a memory storing instructions operative upon execution by the processor to:
receive, from a website or application, a graphical user interface (GUI) definition and a GUI image associated with the website or application;
identify an interactive element in the GUI image, and corresponding code in the GUI definition for the interactive element;
infer, from the GUI image and the GUI definition, a description of the interactive element, the description including, in natural language, a purpose of the interactive element;
generate an annotation for the interactive element, the annotation comprising the description; and
update the website or application based on the annotation.

2. The computer system of claim 1, wherein the inferring of the description comprises providing the GUI image and the GUI definition to a generative artificial intelligence (GAI) model, and obtaining the description from the GAI model for the interactive element.

3. The computer system of claim 1, wherein the instructions are integrated into a web integrated development environment (IDE).

4. The computer system of claim 1, wherein the instructions are further operative upon execution by the processor to:
validate the description, the validation comprising:
executing an action on the interactive element;
receiving an updated GUI image and an updated GUI definition resulting from the executing of the action; and
confirming that the updated GUI image and the updated GUI definition are consistent with an expected result based on the description.

5. The computer system of claim 4, wherein confirming that the updated GUI image and the updated GUI definition are consistent with the expected result based on the description comprises providing the updated GUI image and the updated GUI definition to a generative artificial intelligence (GAI) model and obtaining a determination from the GAI model that the updated GUI image and the updated GUI definition comport with the description.

6. A computerized method comprising:
receiving, from a user, a task description, and providing the task description to a generative artificial intelligence (GAI) model;
receiving, from the GAI model, a plan for completing the task, the plan comprising an action associated with a graphical user interface (GUI) generated by a website or application;
receiving, from the website or application, a GUI definition corresponding to the GUI, the GUI comprising an interactive element, the GUI definition being in declarative textual form and including an annotation for the interactive element, the annotation including a text string describing a purpose of the interactive element;
obtaining, from the GAI model, an action to be performed on the interactive element of the GUI, the action being based on the annotation and the task description; and
transmitting, to a browser or the application, an instruction to perform the action.

7. The computerized method of claim 6 further comprising:
receiving, from the website or application, an updated GUI definition, the updated GUI definition being in response to the transmitting of the instruction to perform the action;
obtaining, from the GAI model, information regarding the task, the information regarding the task being based on the updated GUI definition; and
providing the information regarding the task to the user.

8. The computerized method of claim 6, wherein:
the receiving of the task description, the receiving of the plan, the receiving of the GUI definition, the obtaining of the action, and the transmitting of the instruction are performed by an agent deployed for automating the website or application; and
the method further comprises:
annotating the website or application, the annotating of the website or application comprising:
receiving, from the website or application, an unannotated GUI definition and a GUI image generated by the website or application;
identifying the interactive element visible in the GUI image and corresponding code for the interactive element in the unannotated GUI definition;
obtaining from the GAI model, based on the GUI image and the unannotated GUI definition, the description of the interactive element;
generating an annotation for the interactive element, the annotation comprising the description of the interactive element, the description including a purpose of the interactive element; and
adding the annotation for the interactive element to the website or application.

9. The computerized method of claim 8, wherein annotating of the website or application is performed using software integrated into a web integrated development environment (IDE).

10. The computerized method of claim 8, wherein the annotating further comprises identifying a group of logically related interactive elements and annotating the group with an annotation explaining in natural language the purpose of the group.

11. The computerized method of claim 8, wherein the annotating of the website or application further comprises:
validating the description of the interactive element, the validating comprising:
executing a validation action on the interactive element;
receiving an updated GUI image and an updated unannotated GUI definition resulting from the executing of the validation action; and
confirming that the updated GUI image and the updated unannotated GUI definition are consistent with an expected result based on the description of the interactive element.

12. The computerized method of claim 11, wherein the confirming that the updated GUI image and the updated GUI definition are consistent with the expected result based on the description comprises providing the updated GUI image and the updated GUI definition to the GAI model and obtaining a determination from the GAI model that the updated GUI image and the updated GUI definition comport with the description.

13. The computerized method of claim 8, wherein the obtaining of the description comprises providing the GUI image and the unannotated GUI definition to the GAI model and obtaining the description from the GAI model for the interactive element.

14. The computerized method of claim 6, wherein the website or application is a website, and the receiving of the GUI definition comprises requesting, from an automation interface associated with a browser, hypertext markup language (HTML) code of the website.

15. The computerized method of claim 6, further comprising providing to the GAI model, personalization data associated with the user, the personalization data comprising at least one of information pertaining to a profile associated with the user, information pertaining to preferences associated with the user, and information pertaining to a history of tasks completed on behalf of the user, wherein the plan is based on the personalization data.

16. A computer-readable storage medium storing instructions executable by a processing apparatus to perform operations comprising:
receiving, from a website or application, a graphical user interface (GUI) definition and a GUI image associated with the website or application;
identifying an interactive element visible in the GUI image and corresponding code in the GUI definition for the interactive element;
inferring, from the GUI image and the GUI definition, a description of the interactive element, the description including, in natural language, a purpose of the interactive element;
generating an annotation for the interactive element, the annotation comprising the description; and
updating the website or application based on the annotation.

17. The computer-readable storage medium of claim 16, wherein the instructions are integrated into a web integrated development environment (IDE).

18. The computer-readable storage medium of claim 16, wherein the instructions are further operative upon execution by the processing apparatus to:
validate the description, the validation comprising:
executing an action on the interactive element;
receiving an updated GUI image and an updated GUI definition resulting from the executing of the action; and
confirming that the updated GUI image and the updated GUI definition are consistent with an expected result based on the description.

19. The computer-readable storage medium of claim 18, wherein confirming that the updated GUI image and the updated GUI definition are consistent with the expected result based on the description comprises providing the updated GUI image and the updated GUI definition to a generative artificial intelligence (GAI) model and obtaining a determination from the GAI model that the updated GUI image and the updated GUI definition comport with the description.

20. The computer-readable storage medium of claim 16, wherein the inferring of the description comprises providing the GUI image and the GUI definition to a generative artificial intelligence (GAI) model and obtaining the description from the GAI model for the interactive element.
